(19) United States
(12) Patent Application Publication
(10) Pub. No.: US 2025/0313097 A1
(43) Pub. Date: Oct. 9, 2025

(54) MOTOR VEHICLE WITH A HIGH VOLTAGE BATTERY

(71) Applicant: MAGNA STEYR Fahrzeugtechnik GmbH & Co KG, GRAZ (AT)

(72) Inventors: Manuel ERLACHER, Radenthein (AT); Werner SCHWARZL, Lassnitzhoehe (AT); Christian LIENHART, Seiersberg (AT); Philipp RASTL, Stainz (AT); Severin STADLER, Strobl (AT); Daniel NEUHOLD, Stattegg (AT)

(73) Assignee: MAGNA STEYR Fahrzeugtechnik GmbH & Co KG, GRAZ (AT)

(21) Appl. No.: 19/096,932

(22) Filed: Apr. 1, 2025

(30) Foreign Application Priority Data
Apr. 8, 2024 (EP) 24168891.0

(51) Int. Cl. B60L 50/64; B60K 1/04; B60L 50/60; H01M 10/613; H01M 10/625; H01M 10/6554

(52) U.S. Cl. CPC B60L 50/64; B60K 1/04; B60L 50/66; H01M 10/613; H01M 10/625; H01M 10/6554; B60K 2001/0438; B60K 2001/0472

(57) ABSTRACT

A motor vehicle and a method for manufacturing the motor vehicle. The motor vehicle includes: a high-voltage battery including a battery housing having sidewalls, a cover that covers the sidewalls, a support plate which forms a bottom of the battery housing, and a downwardly open trough member that defines the sidewalls and the cover, the trough member being formed from at least two metal sheets having a different material thickness and/or material quality; a plurality of battery cells arranged in the battery housing; and a support plate, which forms a bottom of the battery housing upon which the battery cells are mounted, and which covers an underside region of the trough member.

### CROSS-REFERENCE TO RELATED APPLICATIONS

The present application claims priority under 35 U.S.C. § 119 to European Patent Publication No. EP 24168891.0 (filed on Apr. 8, 2024), which is hereby incorporated by reference in its complete entirety.

### TECHNICAL FIELD

The present disclosure relates to a motor vehicle having a high-voltage battery and to a method for producing such a motor vehicle.

### BACKGROUND

It is known that high-voltage batteries can be installed in motor vehicles, in particular as a drive battery for providing electrical energy for driving the motor vehicle. The battery then has a battery housing which accommodates the cell modules. Battery housings are usually assembled from various individual parts. The battery housing is installed in an underbody via screws and is removable. The impermeability of the vehicle body is ensured via appropriate components in the undercarriage and is independent of the battery housing. In this case, apart from at the screw holes, there is usually a gap of at least a few millimetres between the battery and the vehicle structure in order to avoid rubbing during operation (noise, corrosion, etc.) but also to avoid collision-free assembly. For maintenance or repairs, the entire battery unit has to be removed from the vehicle.

### SUMMARY

The present disclosure addresses the problem of specifying a motor vehicle having a high-voltage battery, wherein the high-voltage battery has a small space requirement such that the energy content in the high-voltage battery can be increased and thus the range of the vehicle is increased, with the weight and production costs also being low. The present disclosure also addresses the problem of specifying a simple and cost-effective method for producing such a motor vehicle.

The problem is solved by a motor vehicle having a high-voltage battery, wherein the high-voltage battery comprises a battery housing, wherein the battery housing comprises at least sidewalls and a cover that covers the sidewalls at the top, wherein a plurality of battery cells are arranged in the battery housing, wherein the sidewalls and the cover are formed by a downwardly open trough member, wherein a support plate forms the bottom, covering the underside of the trough member, of the high-voltage battery, wherein the battery cells are mounted on the support plate, wherein the trough member is joined together from at least two metal sheets with a different material thickness and/or material quality.

In accordance with the present disclosure, a high-voltage battery has a battery housing which, in contrast to conventional designs, does not use separate lateral housing and frame components and a separate cover, but rather a trough member which forms the sidewalls and the cover, located at the top when installed in the motor vehicle, of the battery housing. In a simple and cost-effective manner, this upside-down trough member can be equipped with further battery components, in particular battery cells, and can be integrated into the structure of the vehicle body. This trough member can, at the same time, close off the undercarriage from below. The trough member can directly adjoin the floor pan of the motor vehicle and/or, for example, form the floor pan in certain regions. An essential advantage of this solution is the increase in installation space in the Z direction, since the air gap, which usually needs to be maintained between the battery cover and floor pan, can be dispensed with here. Dispensing with separate components, such as a separate battery cover or separate side parts or frame parts, may also represent a cost and weight advantage. The trough member is joined together from at least two metal sheets with a different material thickness and/or material quality. The two metal sheets can thus be embodied in an optimal manner, in that different material thicknesses and qualities are used. As a result, a particularly low weight of the battery housing can be achieved. Furthermore, the materials for crash and rigidity requirements of the body can be optimally coordinated.

The battery cells can be mounted on a support plate, which forms the bottom of the battery housing, in a simple and cost-effective manner. After the support plate has been equipped with the battery cells, and preferably following the electrical connection of the battery cells, the fully equipped support plate can be joined to the trough member, in particular screwed thereto, in order to close the battery housing. The finished high-voltage battery can then be installed in a vehicle body, preferably using mechanical joining elements, such as screws or rivets, in addition to an assembly adhesive, such that continuous manufacture of the vehicles is possible without with vehicle having to be unloaded for the adhesive to cure.

Developments of the present disclosure are specified in the claims, the description and the appended drawings.

Preferably, a first metal sheet having a first material thickness and/or material quality substantially forms the sidewalls of the trough member and a second metal sheet having a second material thickness and/or material quality substantially forms the cover.

According to one embodiment, the trough member forms a two-piece component group, wherein the first metal sheet and the second metal sheet are welded together in a flange region and are preferably sealed in the flange region.

According to another embodiment, the trough member has been formed in one piece by blank welding, wherein the first metal sheet and the second metal sheet have already been welded together as a blank and subsequently formed.

Preferably, the battery cells are mounted in a standing manner on the support plate such that the electrical contacts of the battery cells are directed upwardly and the cell bottoms are directed downwardly.

Preferably, the battery cells are mounted, particularly preferably mounted in a standing manner, on a cell support formed integrally by the support plate or joined to the support plate. The battery cells are thus mounted indirectly on the support plate via the cell support.

Particularly preferably, at least one or more planar cooling plates are arranged on the cell support, beneath the battery cells.

The support plate preferably forms an underride guard of the motor vehicle. Accessibility to the battery cells can be ensured from below, via the preferably removable support plate, which serves as an underride guard at the same time.

Preferably, the cover of the trough member forms a floor pan of the motor vehicle and/or the cover of the trough member is fastened from below to a floor pan, in particular screwed and/or adhesively bonded thereto. The cover of the trough member may, for example, form the floor pan in certain regions and be joined to a floor pan, for example, in other regions, in particular at edges. The cover of the trough member may have fastening points for seat cross members. Seat cross members are preferably fastened to the trough member, in particular adhesively bonded and/or screwed to the cover of the trough member.

Preferably, the trough member has been mounted from below on a remaining supporting structure of the motor vehicle, preferably on side sills of the motor vehicle, preferably adhesively bonded and screwed thereto. The sill may have been produced, for example, as a shell construction. The trough member can then be joined to one or more shells of the sill, in each case preferably adhesively bonded and/or screwed thereto. The trough member, in particular sidewalls of the trough member, may form a part of the supporting structure of the motor vehicle, preferably of the side sills of the motor vehicle. For example, a shell of the sill may be formed by a side wall of the trough member.

Preferably, a plurality of cross members of the supporting structure of the motor vehicle are arranged within the trough member of the high-voltage battery. The cross members may be welded to or formed integrally with the cell support. Preferably, the battery cells are each mounted in the intermediate spaces between the cross members in a manner standing on the cross members such that a plurality of parallel rows of battery cells extend between the cross members.

The battery cells may be mounted individually in the trough member or be mounted in a manner combined into battery cell modules. The high-voltage battery can thus have battery modules mounted in a standing manner.

A method in accordance with the present disclosure for producing a motor vehicle, as described above, may provide that the trough member is formed in that the first metal sheet and the second metal sheet are formed and are then welded together in a flange region, or that the first metal sheet and the second metal sheet are already welded together as a blank and are subsequently formed in order to form the trough member.

A method in accordance with the present disclosure for producing a motor vehicle, as described above, may provide that, in a pre-assembly process, the battery cells are placed on the support plate, in particular inserted into the cell support, then the support plate is joined to the trough member, to produce the high-voltage battery, and then the pre-assembled high-voltage battery is mounted from below in a remaining supporting structure of the motor vehicle, and is preferably fastened to side sills of the motor vehicle.

At least one planar cooling element, i.e. a cooling plate, may be arranged, for example placed, on the support plate before the battery cells are mounted. Then, the battery cells are fitted on the support plate, in particular into the cell support. Then, the battery cells can be interconnected.

Then, the support plate and the trough member can be screwed together. The cell support may be embodied as a one-piece cast part, or as a multi-piece welded assembly, or as a material combination, for example, with the support plate being made of fibre-reinforced material such as GFRP and the cell support made of metal, in particular of aluminium.

After the support plate has been screwed to the trough member in order to form the housing, the cells can be connected to plug connections on an end face of the housing, for example through an opening. Then, a closing plate, which also contains the plug connections, can be screwed onto the housing in a gastight manner.

The pre-assembly of the battery housing can take place in the uninstalled state, outside the motor vehicle to be produced.

The pre-assembled battery can be placed on an assembly line and installed in the vehicle from below via conventional manipulation devices.

The pre-assembled high-voltage battery can be mounted from below in a remaining supporting structure of the motor vehicle, preferably fastened to side sills of the motor vehicle, for example screwed thereto.

### DRAWINGS

The present disclosure is described in the following text by way of example with reference to the drawings.

FIG. 1 is a sectional view of a portion of a motor vehicle in a transverse direction of the vehicle (X-section), in accordance with the present disclosure.

FIG. 2a is a sectional view of a portion of a trough member of a motor vehicle in a first embodiment, in accordance with the present disclosure.

FIG. 2b is a sectional view of a portion of a trough member of a motor vehicle in a second embodiment, in accordance with the present disclosure.

FIG. 3 is a sectional view of a portion of a motor vehicle in a longitudinal direction of the vehicle (Y-section), in accordance with the present disclosure.

FIG. 4 is a sectional view of a portion of a motor vehicle in a longitudinal direction of the vehicle (Y-section), in accordance with the present disclosure.

### DESCRIPTION

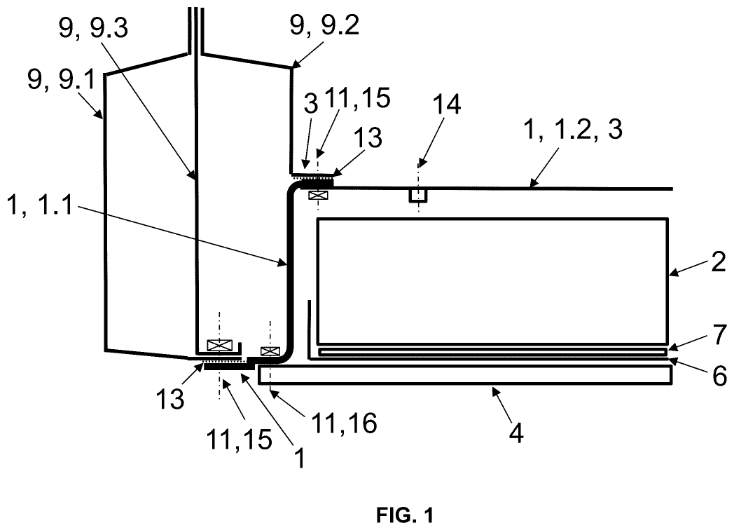

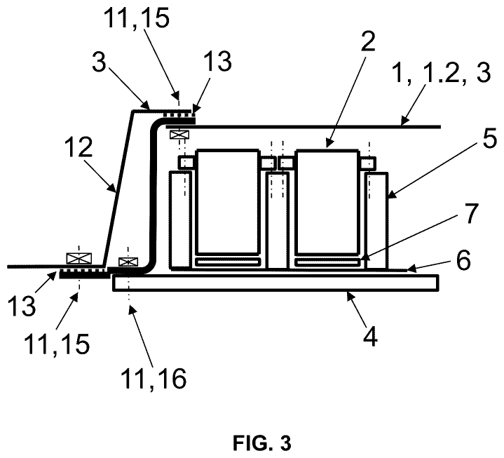

FIG. 1 is a schematic illustration of a high-voltage battery in a trough member 1 of a motor vehicle in a transverse direction, in accordance with the present disclosure. The vehicle is thus seen from the front. In FIG. 3, the same vehicle is illustrated in a section normal to the section in FIG. 1, i.e., in the longitudinal direction of the vehicle, as seen from the side.

The partially illustrated motor vehicle comprises a high-voltage battery, which comprises a battery housing, wherein the battery housing comprises sidewalls 1.1 and a cover 1.2 that covers the sidewalls 1.1 at the top of the sidewalls 1.1. The sidewalls 1.1 and the cover 1.2 are formed by a downwardly open trough member 1.

A plurality of battery cells 2 are arranged in the battery housing, i.e., in the trough member 1. The battery cells 2 are mounted on a support plate 4 in a manner standing within the trough member 1, such that the electrical contacts of the battery cells 2 are directed upwards and the cell bottoms are directed downwards. The battery cells 2 are mounted on a cell support 6 which is joined to or formed integrally with the support plate 4. Planar cooling plates 7 are arranged on the cell support 6, beneath the battery cells 2.

The cover 1.2 of the trough member 1 forms a floor pan 3 of the motor vehicle and is fastened from below, at lateral edges, to a further, peripheral floor pan 3, specifically screwed thereto via screw connections 11 and additionally adhesively bonded, via adhesive 13 between the peripheral floor pan 3 and the cover 1.2 of the trough member 1. The peripheral floor pan 3 can be formed by the sill 9, in particular, by a shell of the sill on the inside at the top 9.2.

The cover 1.2 of the trough member 1 optionally has fastening points 14 for seat cross members. Seat cross members can be fastened directly to the trough member 1, and in particular can be screwed to the cover 1.2.

The trough member 1 is fastened to a side sill 9 of the motor vehicle, specifically mounted from below. The trough member 1 is fastened to the sill 9 via adhesive 13 and a screw connection 11. The fastening to the sill 9 can take place at a lateral edge of the trough member 1, which edge forms a flange parallel to the roadway and to the cover 1.2. In FIG. 1, the trough member 1 is fastened to a shell 9.1 of the sill 9 which forms the outer side of the sill 9. The trough member 1 is additionally fastened, as described above, to a shell 9.2 of the sill 9 which may be located on the inside and may form an upper part of the sill 9. A lower part of the inner side of the sill 9 may be formed by the sidewalls 1.1 of the trough member 1. The sill 9 may additionally have a central reinforcement or shell 9.3. The central shell 9.3 may likewise be fastened to the trough member 1.

The trough member 1, in particular sidewalls 1.1 of the trough member 1, thus form a part of the supporting structure of the motor vehicle, specifically of the side sills 9 of the motor vehicle.

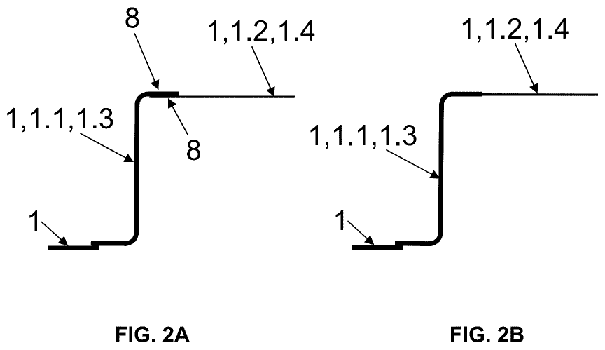

The trough member 1 is joined together from at least two metal sheets 1.3, 1.4 with a different material thickness and/or material quality, as illustrated in FIGS. 2a and 2b. As a result, a weight saving can be achieved via optimal structural thickness distribution.

A first metal sheet 1.3 with a first material thickness forms substantially the sidewalls 1.1 of the trough member 1. A second metal sheet 1.4 with a second material thickness forms substantially the cover 1.2 and thus preferably also forms the floor pan 3.

In the variant in FIG. 2a, the trough member 1 forms a two-piece component group, specifically a welded group. The first metal sheet 1.3 has a material thickness of 2 mm and the second metal sheet 1.4 has a material thickness of 1 mm. The first metal sheet 1.3 and the second metal sheet 1.4 are welded together in a flange region 8 and sealed. The flange region 8 is arranged horizontally.

In the variant in FIG. 2b, the trough member 1 is produced in one piece by blank welding. Two metal sheets with a different thickness are already welded here as a blank and are subsequently formed. The material is thus blank welded with a thickness of 2 mm in the region of the side wall 1.1 of the trough member 1 and with a thickness of 1 mm in the region of the cover 1.2 of the trough member 1.

As is readily apparent from FIG. 3, a plurality of cross members 5 of the supporting structure of the motor vehicle are arranged within the trough member 1 of the high-voltage battery, wherein the cross members 5 may be formed integrally with the cell support 6.

The battery cells 2 are each mounted on the cross members 5 in the intermediate spaces between the cross members 5 such that a plurality of parallel rows of battery cells 2 extend between the cross members 5. The battery cells 2 can be fastened to the cross members 5 via mechanical joining elements 11, such as screws, i.e., for example, screwed thereto.

The support plate 4 forms the bottom, covering the underside of the trough member 1, of the high-voltage battery.

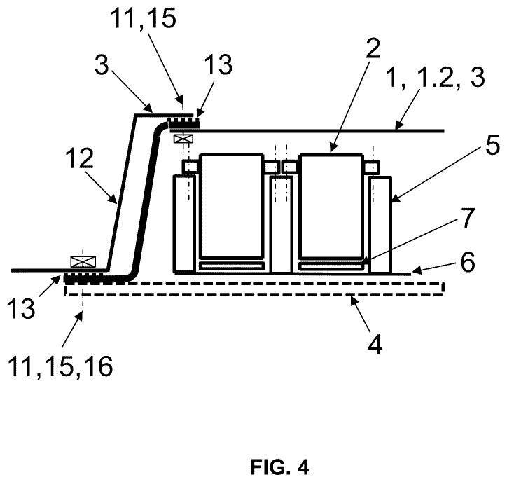

In the embodiment in FIG. 4, the fastening points 16 for the support plate 4 are in the same Y position as the fastening points 15 for the trough member 1. The support plate 4 has openings at the screwing positions of the trough member 1, in order that it can be joined thereto. The advantage of this embodiment resides in the better course of the flow of forces in the event of a side impact, and in an even larger interior of the battery housing.

In the embodiment in FIG. 3, the fastening points 16 for the support plate are located closer to the battery cells 2 in the Y direction than the fastening points 15 for the trough member 1, or between the fastening points 15 for the trough 1, i.e. on the inside.

In contrast to conventional designs, in accordance with the present disclosure, a battery housing such as an upside-down trough member 1 is thus structurally integrated into a vehicle body and at the same time closes off an undercarriage from below. In this case, to join the trough member 1, an assembly adhesive system having adhesive 13 is used, in combination with mechanical joining elements 11, such as screws, rivets, etc. The mechanical joining points 11 allow continuous manufacture of the vehicles without the vehicle having to be unloaded for the adhesive 13 to cure.

The battery modules 2 are in this case arranged in a manner standing on a support plate 4 with an integrated cell support 6 and are installed from below. The support plate 4 is embodied at the same time as an underride guard and is removable again.

The pre-assembly of the battery housing takes place in the uninstalled state. First of all, the cooling plates 7 are placed in the cell support 6, then the cells 2 are inserted from above into the cell support and connected electrically together. Finally, the support plate 4 and the trough member 1 are screwed together. The cell support 6 can be embodied as a one-piece cast part together with the support plate 4, or be embodied as a multi-piece welded assembly or as a material combination, for example with the support plate 4 being made of GFRP and the cell support 6 made of aluminium.

After the support plate 4 has been screwed to the trough member 1, the cells 2 are connected to plug connections on the end face of the housing through an opening. Then, a closing plate, which also contains the plug connections, is screwed to the housing in a gastight manner.

An essential advantage of this arrangement is the increase in installation space in the Y-direction by the cross section that a battery frame usually requires, and the integration of a plurality of components and the associated saving of individual parts and joining technology.

The Z-dimensional chain is likewise smaller on account of the lack of an air gap between the floor panel and battery housing.

As a result of the omission of the battery frame, costs and weight are furthermore saved.

The maintenance or repair of the battery cells 2 can be carried out from above in the uninstalled state of the support plate 4.

### LIST OF REFERENCE SYMBOLS

1 Trough member
1.1 Trough side wall
1.2 Trough cover
1.3 First metal sheet
1.4 Second metal sheet
2 Battery cells
3 Floor pan
4 Support plate
5 Cross member
6 Cell support
7 Cooling plate
8 Flange region
9 Sill
9.1 Sill, outside
9.2 Sill, inside at the top
9.3 Sill, central
11 Screw connection
12 Supporting structure
13 Adhesive
15 Fastening points, trough

16 Fastening points, support plate

What is claimed is:

1. A motor vehicle, comprising:
a high-voltage battery including a battery housing having sidewalls, a cover that covers the sidewalls, a support plate which forms a bottom of the battery housing, and a downwardly open trough member that defines the sidewalls and the cover, the trough member being formed from at least two metal sheets having a different material thickness and/or material quality;
a plurality of battery cells arranged in the battery housing; and
a support plate, which forms a bottom of the battery housing upon which the battery cells are mounted, and which covers an underside region of the trough member.

2. The motor vehicle of claim 1, wherein the at least two metal sheets comprise:
a first metal sheet having a first material thickness and/or a first material quality that substantially forms the sidewalls; and
a second metal sheet having a second material thickness and/or a second material quality that substantially forms the cover.

3. The motor vehicle of claim 2, wherein the trough member forms a two-piece component group that includes the first metal sheet and the second metal sheet that are welded together and sealed in a flange region.

4. The motor vehicle of claim 2, wherein the trough member is formed in one piece by blank welding of the a blank that comprises the first metal sheet and the second metal sheet.

5. The motor vehicle of claim 1, wherein the battery cells are mounted on the support plate for orientation in a vertical direction relative to the support plate such that electrical contacts of the battery cells extended upwardly and bottom regions of the battery extend downwardly.

6. The motor vehicle of claim 1, further comprising a cell support upon which the battery cells are directly mounted.

7. The motor vehicle of claim 6, wherein the cell support is formed integrally with the support plate.

8. The motor vehicle of claim 6, wherein the cell support is attached to the support plate.

9. The motor vehicle of claim 6, further comprising a plurality of cooling plates arranged on the cell support and beneath the battery cells.

10. The motor vehicle of claim 1, wherein the support plate forms an underride guard of the motor vehicle.

11. The motor vehicle of claim 1, wherein the cover of the trough member forms a floor pan of the motor vehicle.

12. The motor vehicle of claim 1, further comprising seat cross members fastened to the cover of the trough member.

13. The motor vehicle of claim 1, further comprising side sills to which the trough member is mounted from below.

14. The motor vehicle of claim 1, further comprising side sills formed at least partially by the sidewalls of the trough member.

15. The motor vehicle of claim 1, further comprising a plurality of cross members of a supporting structure arranged within the trough member.

16. The motor vehicle of claim 15, wherein each battery cell among the battery cells is mounted in intermediate spaces between adjacent cross members such that a plurality of parallel rows of battery cells extend between the cross members.

17. The motor vehicle of claim 1, further comprising:
a cell support upon which the battery cells are directly mounted; and
a plurality of cross members of a supporting structure integrally formed with the cell support and arranged within the trough member.

18. A method for manufacturing the motor vehicle of claim 1, the method comprising:
wherein:
the at least two metal sheets comprise a first metal sheet having a first material thickness and/or a first material quality that substantially forms the sidewalls, and a second metal sheet having a second material thickness and/or a second material quality that substantially forms the cover, and
the first metal sheet and the second metal sheet are formed and are then welded together in a flange region to form the trough member.

19. The method of claim 16, wherein in a pre-assembly process:
the battery cells are inserted into the cell support,
the support plate is joined to the trough member to form the high-voltage battery, and
mounting the pre-assembled high-voltage battery from below to side sills of the motor vehicle.
